(19) United States
(12) Patent Application Publication
(10) Pub. No.: US 2011/0302851 A1
(43) Pub. Date: Dec. 15, 2011

(54) Earthquake-Safe Compact Elevator System With Optional Staircase

(76) Inventor: Gholam Ali Entezari, Vancouver (CA)

(21) Appl. No.: 13/159,393

(22) Filed: Jun. 13, 2011

(30) Foreign Application Priority Data
Jun. 14, 2010 (IR) 389030747

(51) Int. Cl. B66B 9/00; B66B 7/08; E04F 11/032; B66B 7/00

(52) U.S. Cl. 52/30; 187/411; 52/187

(57) ABSTRACT

Provides is an earth quake safe elevator system with optional staircase.

### CROSS REFERENCE TO RELATED APPLICATIONS

The present invention claims the benefit of Iranian Appl. No. 389030747, filed on Jun. 14, 2010, and granted as patent 69454, the entire content of which is incorporated herein by reference.

### FIELD OF THE INVENTION

The present invention relates to the field of construction, particularly construction of an elevator system and staircase structures that are cost effective and earthquake safe and is designed for tight spaces.

### BACKGROUND SECTION OF THE INVENTION

Buildings of different kinds, such as apartment complexes, commercial buildings and office buildings are often made with an elevator and a staircase. The construction of the elevator and the staircase can add substantial cost to a building project. The first problem that increases the cost is the long duration for the construction of the elevator and the stairs. The second problem is constructing the stairs with the height of 15 centimeters instead of 18 centimeters, which is more comfortable. The third problem is the wasted space in the door way that is used for the elevator, which is important in expensive and business buildings. The fourth problem is the lack of harmony in dimension and the position of stairs relative to the elevator. The fifth problem is the large space of counterweight with the frame which in a standard design, comes with two rails for the weight with a bracket, a third rail for the cabin, which if the wall of the well is thin the sound and the vibration will be a problem for the adjacent units. The counterweight also may fall and cause damage or injury during an earthquake. Elevator and staircase construction requires a compact and cost effective design that is also safe during an earthquake.

### SUMMARY OF THE INVENTION

In one embodiment, the present invention provides an earthquake safe elevator system comprising:
a) a hollow pipe in a vertical position;
b) a cabin slidably attached to the outside of the pipe;
c) a counterweight slidably attached to the inside of the pipe;

wherein the counterweight and the cabin are connected to each other so that as the cabin slides along the outside of the pipe, the counterweight slides in the opposite direction inside of the pipe. The pipe can be connected to the inside of a support structure that is parallel to the pipe, inside of which, the support structure defines a shaft for the elevator. The support structure can be a hollow cylinder or a pipe. The support structure can be an alloy fabricated as one piece for purpose of supporting an elevator system inside. The support structure can support stairs attached on the outside of the support structure.

The support structure can have slots for attachment of the stairs. One to four pipes per cabin can be used, with each pipe containing a counterweight. Only three pipes can be used. The elevator cabin can be circular. The pulleys can be used to connect the counterweight with the cabin through a cable. The wheels can be used for having one or more of the cabin or the counterweight sliding against the pipe. There can be four wheels on top of the cabin and four at the bottom, so as to surround the pipe on all sides. The pipe can cut into the cabin to allow for positioning of the wheels on all sides of the pipe. The counterweight can have wheels that slide against inside of the pipe. A helical staircase can surround the support structure, with the elevator system in middle.

In one embodiment, the present invention provides building support structure comprising:
a) a support structure in the form of a cylinder;
b) a hollow pipe in a vertical position attached inside of the support structure in a parallel fashion;
c) an elevator cabin slidably attached to the outside of the pipe;
d) an elevator counterweight slidably attached to the inside of the pipe;
e) a helical staircase with one side of the stairs attached to the support structure;

wherein the counterweight and the cabin are connected to each other so that as the cabin slides along the outside of the pipe, the counterweight slides in the opposite direction inside of the pipe.

### BRIEF DESCRIPTION OF THE FIGURES

FIG. 1 illustrates an elevator system within a support structure, where the elevator slides on three pipes, and a staircase outside of the support structure.

FIG. 2 illustrates the working of an elevator system, with two elevators illustrated on left each having two pipes, and a close up of a pipe provided on the left.

FIG. 3 illustrates the working of the elevator system with a traction machine on top.

### DETAILED DESCRIPTION OF THE INVENTION

The present invention provides for a compact elevator with an earthquake safe counterweight, optionally with a staircase, for rapid installation. The elevator comprises:
a) a hollow pipe in a vertical position;
b) a cabin slidably attached to the outside of the pipe;
c) a counterweight slidably attached to the inside of the pipe;

wherein the counterweight and the cabin are connected to each other so that as the cabin slides along the outside of the pipe, the counterweight slides in the opposite direction inside of the pipe.

The diameter of the pipe (4) is preferably about 10 cm to about 50 cm, depending on the capacity of cabin and can be larger. The thickness of the pipe is preferably about 0.5 cm to about 10 cm, such as about 1 cm depending on the size of the cabin. The length of the pipe is preferably about 2 meters to the height of the building, such as about 2 m to about 12 meters. Standard 2 m sections can be welded together depending on height of the building. Preferably one to four pipes are used, however it is better to have 3 pipes. The pipe preferably also has an opening at the bottom to allow for movement of air as the counterweight moves. The support structure preferably has a diameter of about 1.5 m to about 5 m, such as about 1.5 m. Connectors (16) can be used to connect the pipe (4) to support structure (7, 10).

The elevator cabin can fit preferably one to ten people. The elevator cabin is preferably circular.

Pulleys (3) can be used to connect the counterweight with the elevator through a cable. A motor can be used to move the cabin. The motor can be gearless or with gear. Wheels (rollers) (6) can be used to make sure that the cabin slides smoothly against the pipe. The mechanism is similar to rack and pinion. These wheels are put on the cabin and slidably interact with the pipe. Preferably there are four wheels (6) on top of the cabin and four at the bottom, so as to surround the pipe on all sides. The pipe preferably cuts somewhat into the cabin (9) to allow for positioning of the rollers (6) on all sides of the pipe. The counterweight (5) also has wheels, such as made from Teflon, that slide against inside of the pipe.

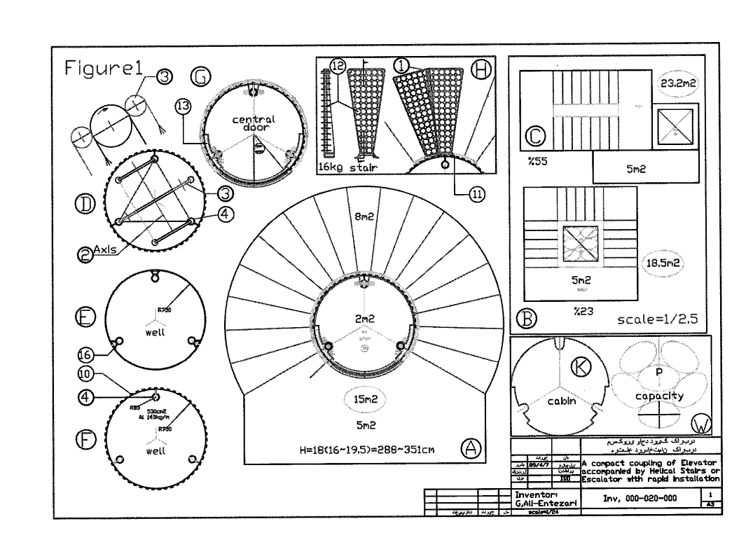

The elevator system is preferably incorporated as part of a staircase structure, with a staircase that is helical. FIG. 1, F, illustrates the circular support structure around the pipes (4). The circular support structure is preferably mass produced wither as one piece with the pipes or have the pipes connected later after production. Part F (10) shows an aluminum structure. Part E shows a simple approach where a bigger standard pipe of a diameter of about 1.5 meters is used to support the three small pipes (4). Preferably, the elevator is circular and a helical staircase is used. The pipe can be used to support the weight of the stairs (Section H in FIG. 1) between floors, as the stairs in between the floors are connected to slots (11) that are part of a structure supported (10) of the pipe. The stairs are manufactured so to fit each other. In one embodiment, at least 20% of the weight of stairs between the floors is supported by the support structure (10). The stairs can be prefabricated and then added to the slots.

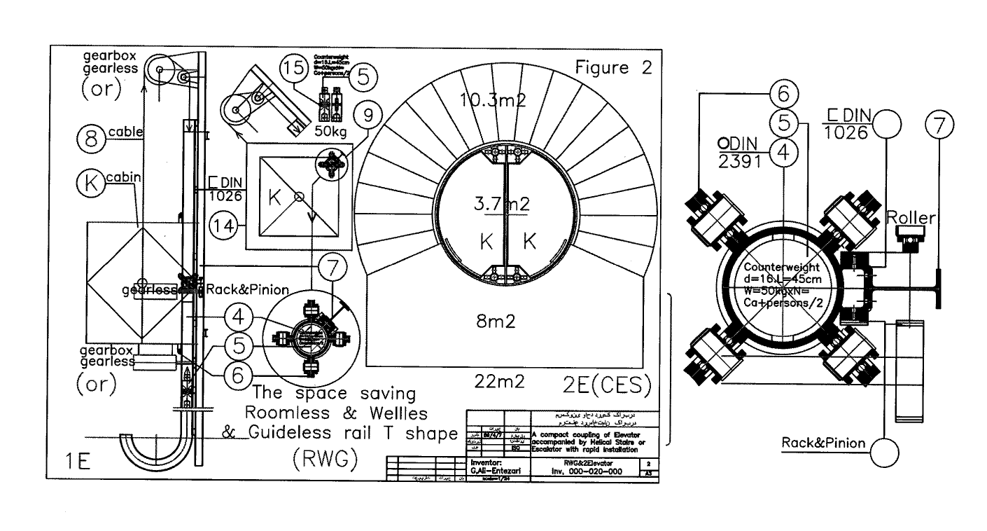

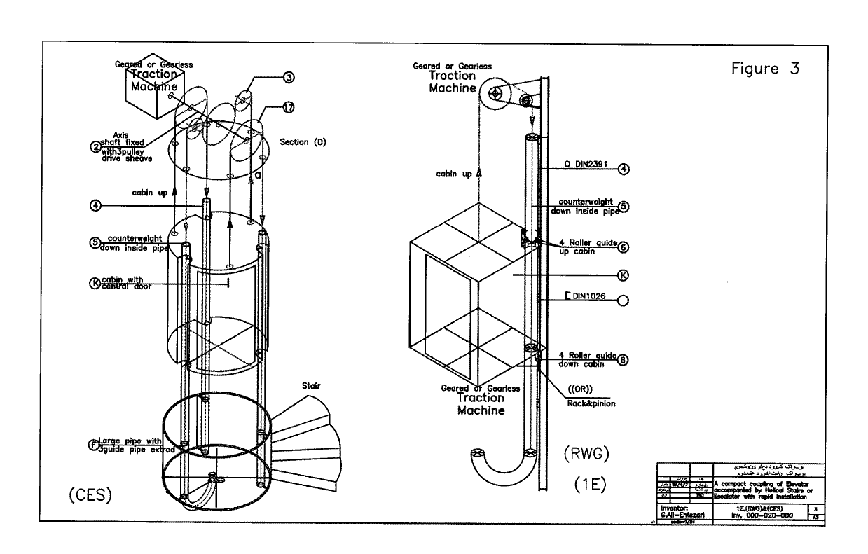

The present invention provides a compact coupling of elevator accompanied by helical stairs or escalator with rapid Installation (CES). The elevator concrete well and the typical stairs are eliminated and instead; an industrial large pipe (4) is used which is applied from outside the pipe for easy stair installation (installation to support structure 10) and it is used from inside the pipe instead of a well. In one embodiment, 3 pipes (FIG. 1) with about 11 cm diameter are used in place of standard 4 T-shaped rail guides and inside of the 3 pipes, there is a passing route of the counterweights. A specific axis and pulley can be used at the top of the well (FIG. 2-3). The cabin (K) can be used with high speed and more smoothness. The manufacturing and executive time are decreased since (CES) occupies a smaller area, makes it worthwhile in terms of space and economy. This system (CES) is designed intelligently, considering having a need in building, it is produced in mass with predetermined standard and is quickly installed even before building of the floors. Using a skilled mechanical worker instead of a manual one for making a concretes well and stairs in a traditional way, provides precision in monotonous height of stairs and the beauty of the design and it increases the speed of the elevator with more smoothness and decreases the space and thus it compensates for the stair and elevator (CES) costs. This system is important as a standard in elevator and stair making industry because of its volume and need in a building for creating jobs and a transformation of the community.

This compact coupling of elevator accompanied helical stairs or escalators (CES), allows for mechanization of making elevators with stairs (CES) so that almost except the foundation, most of the construction such as the concrete well and the ordinary stairs is done by workers skilled in mechanics. The stairs and elevator installation is possible even before constructing the building. A standard dimension can be suggested for the near future

As for elevator, speed of up to about 17 m/s are possible, and even a turn sensor and even the considered floor. This complex eliminates all the constructions such as making well and traditional Stairs and instead, an extrude pipe made of aluminum alloy for example for the capacity of 6 person with a diameter of about 1.5 meter and the length of about 2 up to about 12 meters and the weight of about 140 kg/m with about 51 slots or holes for installing stairs in accordance with the FIG. 1-H and also the cabin K and stairs H are produced in mass numbers such as by using the extrude or die cast method.

Inside the support structure pipe (number 10 in E and F), there are 3 guiding pipes (4) with 120 degree diversion altogether. They can be screwed with a special morsel that is noiseless. It is also of the pipe material made of steel. P (4) shown in FIG. 1, E, can also be selected from steel with holes allocated for joining stairs shown in Figure H, 1. There are 3 counterweights (5) that move inside of 3 pipes (4) by touch rolling Teflons or other similar materials and outside of the pipes for guiding that moved cabin by touch rolling Teflons. In one embodiment, there can be 18 steps (12) at 240 degree from 360 diversion by 34 hole or slots from 51 slots (11) with fixed the same height controllable between 16.5 up to 19.5 centimeters. Height of floors in this embodiment is between about 2.88 up to about 3.5 meters.

At the other side of the steps, the end and the beginning of every step can be controlled by a newel (1 in FIG. 1, H) which is tightened along side handrail guards. Helical escalator can be used instead of fixed stairs.

FIG. 1, Section D (illustrated in detail in FIG. 3) illustrates the drive mechanism for an elevator with three pipes (4). A cable is permanently attached at one end to the top of the cabin(k) The cable (or other connection) then passes through a pulley. The pulley can be a sheave, that is a wheel with a groove so the cable wraps around the wheel. After going around the sheave, the other end of the cable is attached to the counterweight. The sheave for one, two or all three cables can be driven by a motor (drive sheave). In one embodiment, all sheaves are aligned so that all of them are driven be a motor. To obtain the alignment, two smaller sheaves (3) can be attached next to the main sheave, where the cable from the cabin wraps around the small sheave, goes around the large drive sheave, and goes down the small drive sheave. Corrosion and fatigue for the cable with multiple sheaves is more than those with only one sheave.

Instead of the well, the industrial pipe and the stairs are produced in mass. The installation is quick and unchallengeable. For example, the work is done in 10 days rather than 3 months, and can be installed before construction. Supply of force from cables to the cabin is more uniform and the cabin is lighter, and the counterweights inside the pipes safer and in the same way, the cabin guide by rolls over the pipe in 120 degree in relation to each other. All these features allow a higher speed and smoothness. The other advantage is that design A is 23% less space than the design B and 55% less than the design C which is customary and take 3.5 m² and 8.5 m² more space in every floor with the same door way, stair and elevator capacity. The less space needed negates the stair and the elevator cost. The elevator is used in all residential, official and business buildings and is recommended in building of more than 2 floors.

Figure one of the application provides the following illustrations:
Section A displays a design for a CES (Compact Elevator Stair) elevator with integrated stairs which is designed to hold 6 people. The total area is 15 m². This design has saved 3.5 m² and 8.2 m²of area in comparison with drawings in Section B and C respectively.
Section B displays a design for a traditional elevator and staircase with an area of 18.5 m² which can hold up to 6 people.
Section C displays a design for a traditional elevator and staircase with an area of 23.2 m² which can hold up to 6 people.
Section D illustrates (in FIGS. 1 and 3) the room above the cabin where traction sheaves or pulleys that are located on top of the elevator along with a gearless traction machine or geared traction machine and elevator control board along with other conventional accessories. The three drive sheaves or pulleys (17) are connected through a shaft (axle) (2) to the traction machine. The sheaves are positioned along a single axis (2) in relation to a traction machine so all are driven by the same traction machine. Two of the counterweight cables use the first and the third single drive sheaves. The sheave in the middle uses two smaller pulleys (roller sheaves) (3) on each side of the drive sheaves in order to allow reverse direction for cables that is connected to the cabin K and the counterweight.
Section E displays a pipe that is 2 m in diameter and 2.5 cm in thickness. This pipe would replace the concrete well and has 3 smaller pipes inside of it which are 12 cm in diameter. These three pipes will be the cabin (K) guide from outside and from the inside they will guide the counterweights. From the outside of the main big pipe, stairs which are made by an extrusion technique (aluminum alloy) and weigh about 16 Kg are screwed into the main pipe. This connection is shown in figure H which in point 1 of this figure shows the connection of the staircase with the hand rail.
Section F illustrates aluminum alloy support structure produced which was discussed in previous section.
Section G which would be located inside K shows central automatic doors (13).
Section K shows inside of the cabin with capacity for 6 people.
Section H points where (11) the stairs (12) are attached to the support structure and where they attach the hand rail (1).
Section W displays the capacity of the cabin.

FIG. 2 provides the following illustration:
Section 2E shows an elevator system with two integrated cabins denoted as K, showing two cabins independent of each other with a capacity of six persons, with two guide pipes in each cabin which from inside contain the counterweight guide. The entire area is 22 square meters.

Number (14) illustrates a square cabin with capacity for six to eight or 10 passengers.

Number (4) illustrates a single pipe (No. 4 DIN2391) with a cabin K (14) which is square. The pipe (4) has a diameter of 20 cm and thickness of 1 cm and is a seamless steel pipe and guides the cabin from the corner of the cabin with four Rollers (6) at the bottom of the cabin and four at the top of the cabin, positioned 1 cm in the corner of the cabin from outside. Non-contact Guide System and technology magnet rails without noise can also be used in parallel with this system. Inside pipe (4) counterweight (5) with two wheels (15) is used. The cabin and counterweight are connected through a cable as shown in (8). The pipe (4) is connected to beam (FIG. 7) to prevent lateral movement. Traction machine is used on top of support beam (FIG. 7). If instead of square rails, 2 meter pieces of pre-fabricated u-shaped metal hopper component DIN1026 are welded to from pipe (4), and after being carefully positioned to be perpendicular to the ground, is screwed (bolted) to beam (7). On one side of prefabricated piece, rectangular rack rail, guides and wheel are bolted and in the other side a Rack is bolted. Cabin with a traction machine that can be above or below, with installation of a pinion the interacts with the rack that is stationary allows for movement of the cabin. This system eliminates the need for the T-shaped rails, well, and additional equipment above the elevator, which cause noise, and in case of earthquake, allows for safe fall of the counterweight in pipe (4).

The above embodiments are for illustration and are not meant to limit the invention.

What is claimed is:

1. An earthquake safe elevator system comprising:
a) a hollow pipe in a vertical position;
b) a cabin slidably attached to the outside of the pipe;
c) a counterweight slidably attached to the inside of the pipe;
wherein the counterweight and the cabin are connected to each other so that as the cabin slides along the outside of the pipe, the counterweight slides in the opposite direction inside of the pipe.

2. The earthquake safe elevator system of claim 1, wherein the pipe is connected to the inside of a support structure that is parallel to the pipe, inside of which support structure defines a shaft for the elevator.

3. The earthquake safe elevator system of claim 2, wherein the support structure is a hollow cylinder.

4. The earthquake safe elevator system of claim 2, wherein the support structure is a pipe.

5. The earthquake safe elevator system of claim 2, wherein the support structure is an alloy fabricated as one piece for purpose of supporting an elevator system inside.

6. The earthquake safe elevator system of claim 2, wherein the support structure also supports stairs attached on outside to the support structure.

7. The earthquake safe elevator system of claim 2, wherein the support structure has slots for attachment of the stairs.

8. The earthquake safe elevator system of claim 1, wherein 1 to 4 pipes per cabin are used, with each pipe containing a counterweight.

9. The earthquake safe elevator system of claim 8, wherein 3 pipes are used.

10. The earthquake safe elevator system of claim 1, wherein the elevator cabin is circular.

11. The earthquake safe elevator system of claim 1, wherein pulleys are used to connect the counterweight with the cabin through a cable.

12. The earthquake safe elevator system of claim 1, wherein wheels are used for having one or more of the cabin or the counterweight sliding against the pipe.

13. The earthquake safe elevator system of claim 13, wherein there are four wheels on top of the cabin and four at the bottom, so as to surround the pipe on all sides.

14. The earthquake safe elevator system of claim 13, wherein the pipe cuts into the cabin to allow for positioning of the wheels on all sides of the pipe.

15. The earthquake safe elevator system of claim 1, wherein the counterweight has wheels that slide against inside of the pipe.

16. The earthquake safe elevator system of claim 6, wherein a helical staircase surrounds the support structure, with the elevator system in middle.

17. A building support structure comprising:
a) a support structure in the form of a cylinder;
b) a hollow pipe in a vertical position attached inside of the support structure in a parallel fashion;
c) an elevator cabin slidably attached to the outside of the pipe;
d) an elevator counterweight slidably attached to the inside of the pipe;
e) a helical staircase with one side of the stairs attached to the support structure;
wherein the counterweight and the cabin are connected to each other so that as the cabin slides along the outside of the pipe, the counterweight slides in the opposite direction inside of the pipe.
